(19) United States
(12) Patent Application Publication
(10) Pub. No.: US 2006/0199155 A1
(43) Pub. Date: Sep. 7, 2006

(54) System and method for automated dietary planning

(76) Inventor: Michele L. Mosher, New York, NY (US)

Correspondence Address: Charles B. Lobsenz;Roberts, Mlotkowski & Hobbes, PC, Suite 850, 8270 Greensboro Drive, McLean, VA, 22102, US

(21) Appl. No.: 11/069,096

(22) Filed: Mar. 1, 2005

(51) Int. Cl. G09B 19/00

(52) U.S. Cl. 434/127

(57) ABSTRACT

A novel system and methodology for dietary and medical treatment planning wherein meals and treatment plans are specifically individualized for a user according to a number of unique characteristics associated with that user. These characteristics are provided to the system of the present invention and one or more resulting meal plans and/or therapies are generated. According to the present invention, particular dieter specific characteristics that may be considered in developing the meal plan include daily caloric limitations and or recommendations, daily nutritional requirements including minimum and maximum vitamin, mineral, water, and electrolyte intake as well as specific genetic characteristics concerning the individual. Dieter food preferences and other factors may also be considered. The system of the present invention uses this dieter specific information to generate one or more meal plans for that dieter in connection with an ingredient, food, supplement, drug and recipe database containing a universe of foods, supplements, and drugs available for generating meals and treatment plans in accordance with the diet. The system of the present invention may function as a standalone application or it may be web-based wherein users may access the application on a server accessible through the internet or some other public or private network.

### BACKGROUND

1. Field of the Invention

The present invention relates generally to diet, nutrition, meal, and medical treatment planning and more particularly to systems and methods for determining one or more preferred dietary plans based upon specific characteristics of an individual.

2. Background of the Invention

Recent studies have concluded that excess weight and the various resulting health complications is becoming a problem reaching epidemic proportions both in the United States and elsewhere. The general view is that changes in the way people eat and in their lifestyles in recent years has contributed to cause an alarmingly large proportion of the population to carry more weight than is ideal for optimal health. In fact, despite many decades in the US of increasing life expectancy, for the first time some believe that in the upcoming decades, the US may see life expectancies decline in large part because of the prevalence of overweight and obesity in today's population.

Results of the National Health and Nutrition Examination Survey (NHANES) 1999-2000 indicated that an estimated 64 percent of U.S. adults are either overweight or obese, defined as having a body mass index (BMI) of 25 or more. Recent studies have also shown 30% of all children are overweight or obese. BMI is a common measure expressing the relationship (or ratio) of weight-to-height. It is a mathematical formula in which a person's body weight in kilograms is divided by the square of his or her height in meters (i.e., wt/(ht)²). The BMI is more highly correlated with body fat than any other indicator of height and weight. Individuals with a BMI of 25 to 29.9 are considered overweight, while individuals with a BMI of 30 or more are considered obese.

It is generally agreed that there are two primary drivers behind weight control, the first being exercise and the second being the limitation of caloric intake in relation to the amount of calories used by the body during each day. In reference to caloric limitation, an almost unlimited number of diets have been created towards the goal of weight loss. In many cases, these diets are embodied in items such as guide books and other written materials which describe the essential elements of the diets including, in many cases, the theory behind the diets and why they should work. Most of those diets, although not mentioned in the diet theory, are standardized on 1400 calories per day. In addition to written materials, many diets are also made available through or in connection with supplemental activities such as user groups and meetings, one-on-one counseling and other tools and techniques for educating and motivating dieters.

In recent years, the undeniable benefits of computers and the Internet have been employed in connection with diets and their supplemental activities. For example, many companies in the diet industry now offer websites which function to enhance the “diet experience” by providing offerings such as information about the diets, sample meal plans and recipes, forums for dieter support and interaction, and the ability to customize meal plans based upon various individual characteristics and desires. In addition, there exist various computer programs which function to generate meal plans, educate about diets and dietary needs and, in general, assist an individual in adhering to a dietary plan that has been designed for some purpose such as weight loss, muscle building, etc.

Most of the existing computer applications associated with dieting, whether they are standalone software or an internet based solution, tend to focus specifically on caloric intake without taking into account other specific dietary requirements necessary for good health and nutrition. For example, many computerized “meal-generation” applications simply start with a maximum daily caloric intake amount recommendation (such as 1500 or 2000 calories) and then select meals from a database solely on the basis of the calories associated with those meals so as to meet the maximum caloric intake criteria. Typically, with these systems, individual micronutrient nutritional requirements are not measured.

While these applications are certainly beneficial, they do suffer from some drawbacks. In particular, these applications typically do not take into account a number of individual characteristics that are believed to be exceedingly important in terms of diet success as well as overall health. For example, many of these applications will query the dieter for his or her weight and make a generic daily caloric intake maximum determination based upon that one data point alone. Some applications will go a step further and also break down the planned meals in terms of predetermined percentages of macronutrients; fats, proteins and carbohydrates. For example, many low carbohydrate diets are currently in vogue. But, again those solutions do not calculate and provide for individual needs for micronutrients or subdivide macronutrients (i.e. the components of carbs cannot be adjusted to restrict sugar intake amounts versus another macronutrients, i.e. fiber). Proper nutrition is required for optimum health while losing weight, and also especially for individuals with diseases such as diabetes or heart disease or those that are prone for diseases who are or are not attempting to lose weight.

Since the nutrients that provide calories in food are limited to fat, protein and carbohydrates, many software tools for diet planning begin and end with food selection only according to composition of these three components. In some cases, these applications also permit dieters to provide preferences as to which foods they like and which they dislike. While meal planning according to these factors can provide benefits, often they leave dieters with meal constructs that are less than ideal.

For example, since nutritional compositions other than calorie-providing nutrients (fat, protein, and carbohydrates) are typically not taken into account, meal plans may be too low or too high in micronutrients. These types of nutrients include vitamins and minerals for which recommended daily minimums and maximums have been set. Small amounts of vitamins are essential for life. However, vitamin levels that are too high can cause serious side effects. Dietary Reference Intakes, or DRIs, are used to guide a person's intake of vitamins. DRIs for a particular vitamin are broken down by life-stage and gender groups. These groups reflect a person's age and sex. Four reference values are included in the DRIs.

Estimated Average Requirement, or EAR. This is the daily intake needed to meet the requirements of half the people in a particular group.

Recommended Daily Allowance, or RDA. This is the daily intake that is needed to meet the needs of most individuals in a group.

Adequate Intake, or AI. This value is used when the EAR cannot be determined. It is an estimate of the average daily intake needed for a group.

Tolerable Upper Intake Level, or UL. This is the highest daily intake that a particular group can have without side effects.

Vitamins are divided into two groups: fat soluble and water soluble. The fat-soluble vitamins are A, D, E, and K. Sources of these vitamins include dairy foods, fat, oils, and the fat-containing parts of grains and vegetables. Water-soluble vitamins dissolve in water-based fluids. These include the eight B vitamins (B1, B2, B3, B6, B12, folate, biotin, and pantothenic acid) as well as vitamin C.

Foods also contain water which should be an essential component of diet planning and health maintenance. When foods supply mainly calories and few nutrients they are known as “calorie-dense”. In most cases, it is best to avoid such foods and instead opt for foods that provide a good balance of both calories and nutrients. Unfortunately, many diets and related computer applications do not take this into account. Similarly, various other specific characteristics of individual dieters are often not taken into account in diet planning. As stated above, this typically results in less effective progress towards weight loss (or muscle gain) goals and/or poor nutritional balance. For example, each individual has differing daily caloric requirements based upon a number of factors such as weight, height, basal metabolic rate, age, body composition (how fat and muscle are distributed within the body) and physical condition and typical activity level. In many cases, meal planning applications do not take many of these factors into consideration in generating a diet plan and, as a result, generate meal plans that are less than ideal. Also, the current available products to not allow consumers to create custom diets for groups of individuals.

Another emerging area of study relating to diets and dieting is that of “nutrigenomics”. Approximately 40 micronutrients are required in the human diet. Deficiencies in micronutrients can cause DNA damage and may be associated with a number of serious human diseases. Nutrigenomics is the study of how different foods may interact with specific genes to increase or decrease the risk of DNA damage thus causing common chronic diseases such as type 2 diabetes, obesity, heart disease, stroke and certain cancers. Nutrigenomics also seeks to provide a molecular understanding of how common chemicals in the diet affect health by altering the expression of genes and the structure of an individual's genome. The premise underlying nutrigenomics is that the influence of diet on health depends on an individual's genetic makeup, and further, if the diet is deficient in micronutrients DNA damage can occur. Adjusting human metabolism through diet, which would be specific for individuals with similar genotypes and ages, may minimize damage to chromosomal and mitochondrial DNA optimizing health and prolonging the quality of life. Establishing optimal micronutrient intakes should reduce the risk and onset of certain cancers, and other degenerative diseases associated with aging.

Current diet planning tools do not take into account these newly understood relationships between genes and food and the resultant effects on the body. As a result, meal plans are not tailored to individuals based upon their genetic makeup and are therefore not ideal. Therefore, these meal plans do not leverage these interactions, more and more of which are being understood everyday, to assist dieters in achieving their weight loss or total health goals. Perhaps more importantly, diet plans as currently developed, do not effectively leverage these known interactions to avoid “problem” foods for particular individuals with particular genetic characteristics, nor do they increase consumption of certain foods that may improve certain gene related health problems through nutrient therapy.

In addition to the aforementioned drawbacks and as a general rule, diets, diet plans and systems and methodologies for generating the same do not offer the ability to customize for a user or set of users based upon combined characteristics such as combinations of personal food preferences, nutritional factors, genetic factors and medical and other drug treatment therapies and related constraints.

### SUMMARY OF THE INVENTION

It is therefore a primary object of the present invention to provide a system and method for automated dietary planning which improves upon prior art methodologies and their related drawbacks and limitations as described above.

It is another object of the present invention to provide an automated system for generating meal plans that include recipes for dieters.

It is yet another object of the present invention to provide an automated system for generating meal plans wherein a multitude of characteristics, such as but not limited to, preferred foods, nutrient requirements, caloric requirements, food allergies, budget, cooking time constraints, cooking sophistication, etc., concerning the dieter are factored into such meal plans.

It is a still further object of the present invention to provide an automated system for generating meal plans in which micronutrient and other nutritional requirements including non-caloric nutrient requirements are considered in generating such meal plans.

It is an even further object of the present invention to provide an automated system for generating meal plans in which genetic characteristics specific to a dieter are considered in generating such meal plans.

It is a yet further object of the present invention to provide a methodology for generating meal plans based upon a number of characteristics of such individuals including personal preferences, nutrient requirements, caloric limitations, genetic makeup, and/or combined with an exercise, medical or drug treatment and therapy.

It is a still further object of the present invention to provide an automated system for meal planning which may be accessed via one or more of a variety of computing devices such as through a pc, kiosk, PDA or other device in either a standalone or server based environment through a series of user-friendly interfaces.

It is a yet further object of the present invention to provide a meal planning system which offers various reporting and tracking tools.

It is still a further object of the present invention to provide an automated system for diet planning which operates to selectively purchase the food recommended within a menu plan

It is still a further object of the present invention to provide a nutritional, supplement, and medical treatment therapy plan (for weight loss or other medical conditions), further permitting the user to input data during therapy to track progress, allow other professionals to interact with the patient's therapy and patient record, and track and report on the progress of the therapy.

It is a yet further object of the present invention to provide a system which operates to provide the aforementioned meal planning and other functions with respect to individuals as well as to groups of individuals.

These and other objects of the present invention are obtained through the use of a novel system and methodology for dietary planning wherein meals, supplements, exercise, medical treatments, are specifically individualized for a person or group of people according to a number of unique characteristics associated with each person. These characteristics are provided to the system of the present invention and one or more resulting meal plans or treatment therapies are generated. According to the present invention, particular dieter specific characteristics that may be considered in developing the meal plan include daily caloric limitations and recommendations, daily nutritional requirements including minimum and maximum vitamin and mineral intake, water and electrolytes, as well as specific genetic characteristics concerning the individual. Dieter food preferences and other factors may also be considered. Medical, exercise, or drug treatments may also be considered. The system of the present invention uses this dieter specific information to generate one or more meal plans or therapies for that dieter or group of dieters in connection with an ingredient, supplement, drug, medical treatment, food and recipe database containing a universe of foods and meals, supplements, drugs, and medical treatments available for generating meal plans in accordance with the diet. The system of the present invention may function as a standalone application or it may be web-based wherein users may access the application on a server accessible through the internet or some other public or private network.

These and other advantages and features of the present invention are described herein with specificity so as to make the present invention understandable to one of ordinary skill in the art.

### BRIEF DESCRIPTION OF THE DRAWINGS

FIG. 1 is a block diagram illustrating the components of the system of the present invention in a preferred embodiment;

FIG. 2 is a flowchart illustrating the process for establishing a new user and developing a diet plan for that user according to a preferred embodiment of the present invention;

FIG. 3 is an exemplary input screen shot through which a user may enter personal information according to a preferred embodiment of the present invention;

FIG. 4 is a flowchart illustrating the specific steps in generating a meal plan for a user according to a preferred embodiment of the present invention; and

FIG. 5 is a flowchart illustrating the specific steps in generating a meal plan for user in which genomic information is used according to a preferred embodiment of the present invention.

### DETAILED DESCRIPTION OF THE INVENTION

The present invention for automated dietary planning is now described. The present invention comprises a system for generating meal plans which are customized based upon a number of unique characteristics specific to the dieter or group of dieters. The present invention further comprises a process therefor. In the description that follows, numerous specific details are set forth for the purposes of explanation. It will, however, be understood by one of skill in the art that the invention is not limited thereto and that the invention can be practiced without such specific details and/or substitutes therefor. The present invention is limited only by the appended claims and may include various other embodiments which are not particularly described herein but which remain within the scope and spirit of the present invention.

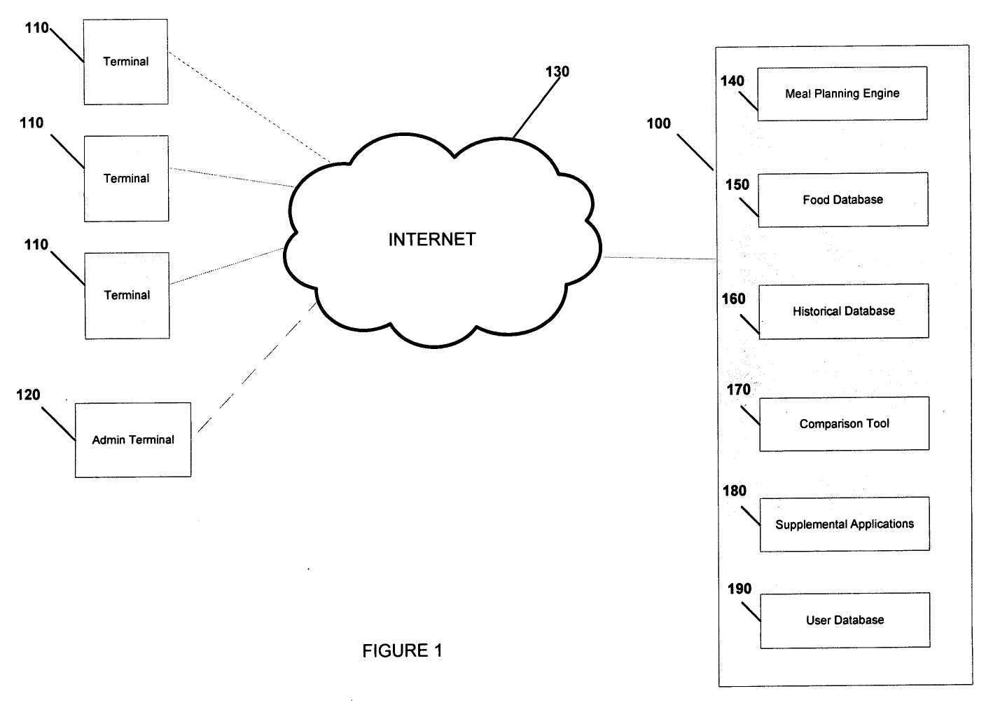

FIG. 1 is a block diagram of the system of the present invention in a preferred embodiment thereof. According to this preferred embodiment, one or more user terminals 110 communicate through the internet 130 with automated meal planning system (AMPS) 100. Terminals 110 may be, for example, a personal computer with the ability to input and view data. In addition, preferably at least one administrative terminal 120 exists for the purpose of permitting a system operator to make changes to and interface with the operation of AMPS 100 and its individual components.

A number of alternative embodiments for communication are also possible. For example, administrative terminal, rather than communicating with AMPS 100 through internet 130, may be directly linked to AMPS 100 without the need for a network or alternatively, the link may be through a private network. Similarly, user terminals 110 may interface with AMPS 100 either directly or through a network other than internet 130 such as through a private network.

In the embodiment shown in FIG. 1, AMPS is essentially operating as a server based application accessed via remote clients. While this is a preferred embodiment, the invention is not necessarily limited thereto. For example, much of the functionality of AMPS 100 may be embodied in a stand alone software application that resides on, for example, a personal computer. In connection with this alternative, functionality requiring updates and/or interaction with other users and/or access to data associated with other users may be obtained, for example, via periodic user initiated communication with one or more central servers connected through the internet 130 and to other users 110 or to AMPS 100 directly.

Turning now to FIG. 1 and the specific components of AMPS 100 in a preferred embodiment, a general overview description of each component is now provided. Additional details of these components and their operation is provided below. Meal planning engine 140 is at the heart of AMPS 100. Meal planning engine operates to prompt for various inputs from a user or group of users in order to generate meal plans customized for that user or group of users. Meal planning engine 140 contains various algorithms (discussed below) for generating meal plans that meet specified criteria such as maximum caloric intake, minimum nutritional intake, gene data, and specific food preferences. In performing these operations, meal planning engine may query food database 150 which contains the universe of known foods, ingredients, meals, and recipes which are the building blocks of meal plans. Food database 150 may be periodically updated with additional foods, meals, ingredients and recipes via, for example, administrator terminal 120, or by users using, for example, terminal 110.

Historical database 160 may contain various data records indicative of previously generated meal plans, user feedback on these meal plans, historical information on user supplied data in connection with the generation of meal plans and other data saved in connection with the ongoing operation of AMPS 100 over time. Meal planning engine 140 may access historical database from time to time in connection with the generation of meal plans. More details on this aspect of the operation of AMPS 100 are provided below.

Comparison tool 170 is an available function for comparing foods, recipes, meals and diets based upon a number of factors such as nutritional content, time to cook, costs and taste ratings. Comparison tool 170 operates in connection with food database 150 to present users with informative reports to assist them with their diet selection and in connection with the generation of meal plans through the use of meal planning engine 140.

Supplemental applications 180 component represents what may be one or more of many supplemental functions available through AMPS 100 associated with dieting, meal planning, nutritional analysis, motivational tools and other related functions. These features may be selectively available to users depending upon their service and/or registration levels. Examples of these applications may include a shopping list tool, chat rooms, message boards, reporting and tracking tools, diet comparison tools and the like.

User database 190 is component of AMPS 100 that stores information concerning users of the system and related information. User database 190 may contain for example, general information about a user such as name, address, etc., personal physical characteristics such as height, weight, age, etc., transactional information for billing purposes such as credit card information and meal planning information including historical meal plans generated for that user over time as well as other information specific to each user using the system.

Now that a general overview of the system of the present invention as well as its various components in a preferred embodiment has been provided, a more detailed explanation of the operation of the system follows.

AMPS 100 has many functions and features which are described herein. In order to describe the present invention, various exemplary interactions with AMPS 100 via terminal 110 or via admin terminal 120 are presented. While these features and functions are preferably included in the capabilities of the system of the present invention, the scope of the present invention is not limited thereto and various modifications to the examples and functions may be made without departing from the scope or spirit of the present invention.

New Client Setup and Initial Meal Planning

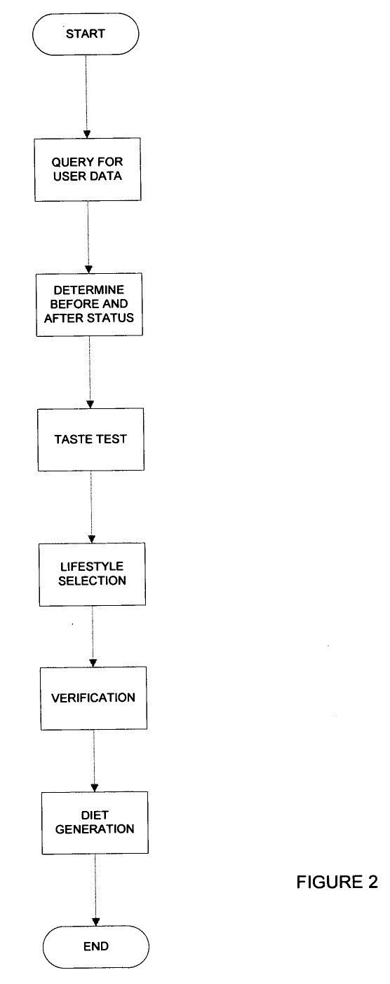

One primary feature of the present invention is the capability for AMPS 100 to generate a user diet based upon specific criteria (i) entered by the user, (ii) available in the databases of AMPS 100, and/or (iii) available externally from AMPS 100. The overall process for doing this in a preferred embodiment is illustrated by the flowchart provided as FIG. 2. Prior to generating a user specific diet with specific nutritional components (a “Nutritional Based Diet”) according to the teachings herein, the user must first provide some level of basic information to AMPS 100. This is preferably accomplished in a web-based embodiment via user input in response to user interface screens generated by meal planning engine 140 via terminal 110. Alternatively, in a stand alone environment (not as shown in FIG. 1), one or more software programs wholly resident on, for example, a user's personal computer may interact with user as described below.

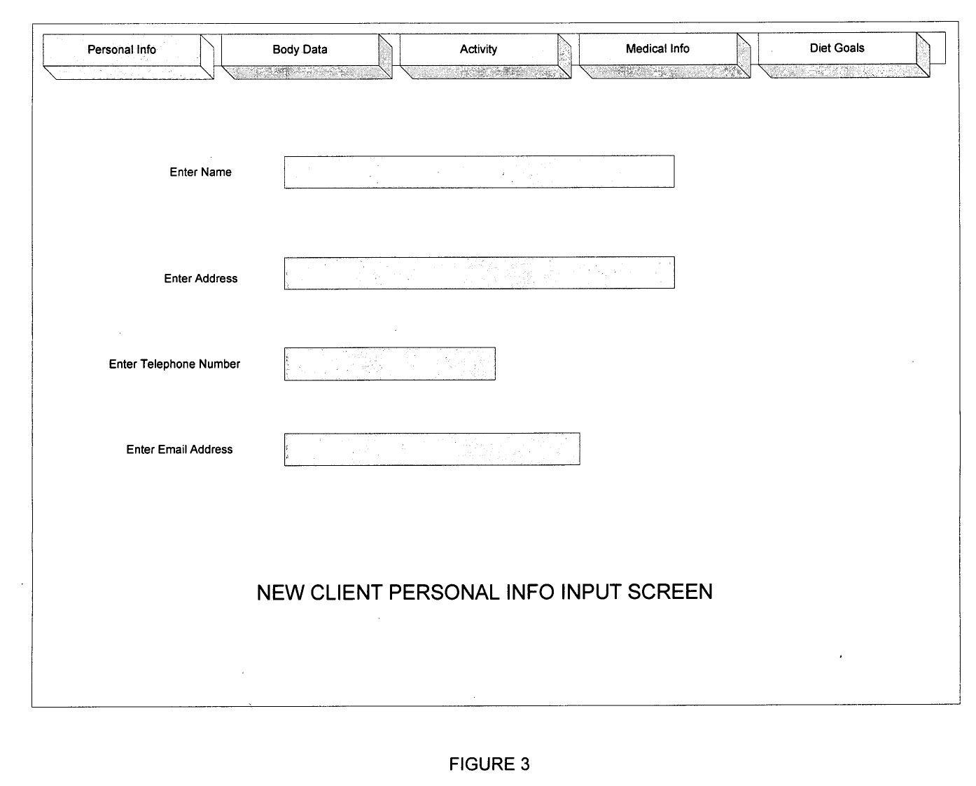

An exemplary user interface screen which may be presented to a user for establishing a new client account and providing the input data necessary to generate a diet plan is provided in FIG. 3. In a preferred embodiment of the present invention, the following interaction occurs between a user and AMPS 100 to establish a new client setup or to set up a group of users:

The user logs into web site or software program and then clicks on the create new user icon or create a group of users. The user then enters, for example, the following personal information for one user or for each user:

1. Name, address, telephone, email

The user may then be informed that there are a number of steps to develop the diet, the BodyPrint, a Taste Test, and a Lifestyle Profile. Initially the user is prompted to the BodyPrint screen which includes boxes to check or enter information concerning some or all of the following:

2. Body Data

gender, birth date, height, weight, desired weight, if pregnant or nursing, body frame, size measurements for biceps, triceps, forearms, neck, chest, waist, hips, upper thigh, mid thigh, knee, calves, ankle, dress size, shirt size, pant size, metabolic heart rate, current body fat percentage, desired body fat percentage, fat calculation method

3. Activity

current or planned daily activity level, daily exercise goals (# of calories to burn each day or can click through activity options)

4. Medical Information

Doctor, name, phone, address, email, medicines or vitamin supplements they are taking, medical conditions (current illnesses, diseases, and history of dieter's and family's medical conditions), blood type, chemistry, cholesterol, hdl, ldl, vldl, triglycerides, blood sugar, Berkley CHD profile, chorisol stress hormone, serotonin, TSH T3 & TSH T4—thyroid, PCOS—polly cystic ovary syndrome, lepton, 4:5 & 3:3 & ? Gene/DNA code present?, white blood cell count, red blood cell count, urine specific gravity, urine protein, urine ketones, urine glucose, uric acid, transferring saturation, protein/total serum, potassium, phosphorous, neutophils, monocytes, magnesium, lymphocytes, iron/serum, iron binding capacity, hemoglobin, hemotocrit, glucose, globulin, eosinophilis, calcium/blood, basophiles, albumin, alcohol, smoker/what?, menstruation/when, ovulation, blood pressure, body temperature

5. Diet goals

nutritional goals with ability to edit and buttons that allow the user to change the PFC (protein, fat, carb) ratios, and nutrients per person, Carb ratios (the daily carb ratio is the percentage of high complex carbohydrates versus low complex carbohydrates allowed on the diet), sugar, set alarms, set success criteria, desired date to reach desired weight, indicate if the goal is to lose weight, gain weight, build muscle mass, or follow a strict eating plan for basic nutritional value or to treat a medical condition.

Each of the numbered items above may represent a tab on a data input screen as shown in FIG. 3. By selecting each tab the user can fill in some or all of the requested information in the applicable data fields. Assistance may be needed in providing some information such as the medical information which may be obtained from a user's physician following testing and examination. Through password protection, a medical professional may also input some or all data on this screen, or through an automated process certain data may be uploaded into the system.

AMPS 100 may require certain data to be provided (e.g. name, height) before permitting the user to proceed while other data (e.g. ovulation information) may be optional. Some data may be required only because of data provided in other fields (e.g. if a user provides data representing a particularly high blood pressure, a cholesterol value may be required before proceeding).

Once the appropriate data has been provided, AMPS 100 may cause a popup window to be displayed which indicates, based upon information input by the user, how many pounds/week must be lost to meet the desired goal and whether such a weight loss plan is safe or not. Based upon this determination, a user may be given the opportunity to revise their goals either in terms of amount of weight loss and/or date by which the goal is to be achieved. At this time, the user may also review and or edit all previously entered data for accuracy. The key data to be generated at this stage is a calculation of recommended daily caloric intake, energy expenditure through exercise, and daily nutrient requirements for the individual or group of individuals that will later be used by the AMPS 100 system.

The next step in the process following the receipt of input data from the user is the determination by AMPS 100 of BEFORE and AFTER states for the user. According to this feature, a screen is available to the user that indicates the BMI, weight/height of the person in x month intervals for x years should the person continue his/her current lifestyle (BEFORE state). Separately, another screen is available to indicate the planned BMI, weight/height of the person in x month intervals for x years should the person follow the meal plan proposed for the user by AMPS 100 and generated as described in detail below.

The next step in the process is to present the user with a “Taste Test” input screen that allows them to check boxes indicative of (for example): foods they dislike, foods they really like, consistencies they dislike, food allergies they have, food intolerances, digestive problems, religious dietary requirements, cultural preferences, sophistication of the palate or cooking skills, if the user(s) prefer foods cooked well/med/done, etc.

As the process continues, the user is next presented with a “Lifestyle Profile” selection screen asking them to check and provide input for the following characteristics (for example): budget, food prep time, delivery requirements, ingredients limitations, home prepared/cooked, online food shopping or travel to a store, family meals or eat on the go, eat at home or out, and restaurant preferences.

In each of the previous steps, the user is preferably prompted to indicate whether he or she is designing a diet for one individual or a group of individuals. If the user selects a group, the user is prompted at each stage to repeat the process for each person in the group, or the user has the option to add users at the end of the entire process, or may add users at a later date.

The next step in the process calls for the user to verify the data provided. The user is presented with a screen that displays back the information entered and allows them to edit any data, and select a start date for the diet, then presses ok. At this point, all data supplied by the user is stored in one or more records associated with that user in user database 190.

The final step in this process is for AMPS 100 to design the meal plan for the user(s) based upon the provided input, internal system data and external data as appropriate. The details of this step in the process are provided below. Once the meal plan has been generated, the user may next be directed into a food log and be shown the first day's meal plan.

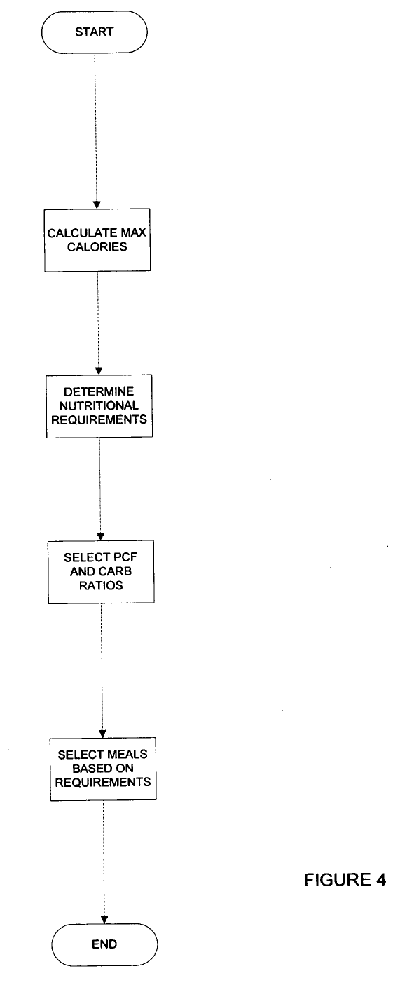

According to a preferred embodiment of the present invention and as shown in FIG. 4, a personalized meal, exercise, supplement, and or medical plan is created for the user by AMPS 100 as follows. First, data for the user's bodyprint is established. According to this methodology, age, gender, height, weight, planned activity level are used to calculate caloric intake requirement. In this way, the user's daily allowable caloric intake is calculated as follows:

1. the user's BMR (formula based) is added to the planned energy expenditure (kj) (formula based) number to determine the number of daily calories that user's body will burn each day;

2. then the number of pounds the user needs to lose per week is converted into calories and that sum is deducted from the planned energy expenditure number to arrive at the user's daily allowable caloric intake.

Next, the user's nutritional requirements are determined. Based on the age and gender of the user, AMPS 100 in general and meal planning engine 140 in particular uses the American Dietary Association's Recommended Daily Allowances of nutrients to determine the daily intake nutrient requirements of the user. Other sources could also or alternatively be used. There are minimums and maximums for each nutrient, and the allowable range is provided by person for each nutrient.

Next, a protein, carbohydrate, fat (PCF) ratio and a Carb ratio are selected for the user. The daily carbohydrate ratio is the percentage of high complex carbohydrates versus low complex carbohydrates allowed on the diet. Then medical conditions (illnesses, diseases, history of disease of user and user's family) for the user are retrieved from user database 190.

In a preferred embodiment, food database 150 houses all available recipes, meals, and food items. This database 150 provides all calories, pcf ratios, and nutritional information for all food and recipe items. Initially, meal planning engine 140 combines recipes that create whole snacks and meals for breakfasts, lunches, and dinners, or whole meal plans from a database of meals. If one specific diet were being designed for one specific user, the number of calories per meal and snack for that user would be determined. For example, if the user should eat 1200 calories/day each meal should have 300 (+50 or −50) calories and each snack should have 100 calories (+30 or −30) so the combined meals and snacks should sum 1200 calories.

Meal planning engine 140 then sorts through a list of meals, snacks, recipes, food items, and beverages (which all have calories and nutrient amounts defined per meal, snack or recipe or food item) and selects/combines various items whereby the end result is a day's list of food for breakfast, morning snack, lunch, afternoon snack, dinner, and an evening snack that meet the daily caloric, preferred PCF ratio, preferred carb ratio, and daily nutritional requirements.

After each item or items are selected, the total daily calories, PCF ratio, and nutritional % met of RDA are calculated. These results are then compared as against a database with the RDA minimums and maximums of each nutritional value, and meal planning engine 140 determines if the nutrient falls within the daily allowable nutritional range. If not, the nutrients falling outside the range are noted, and adjustments are made to the daily food items and this process is repeated until a full day's of meals are recorded that meet the calorie, nutritional and pcf ratios.

Also, when selecting food, snack, meal items, meal planning engine 140 must access, for each individual user or group of users, the list of foods allowed and disallowed to confirm eligibility of each recipe based on the user's preferred food tastes and lifestyle. This process is repeated for the number of days the user needs to be on the diet to achieve the desired weight. In a preferred embodiment, there is a requirement to not repeat recipes within the first 21 day cycle then recipes can be repeated only within 6 day cycles thereafter. Further, in a preferred embodiment, each day limits to only one serving of beef, poultry, fish, a vegetarian dish, pasta, or certain foods, meals, and or recipes each so foods are not repeated. Recipes that indicate a leftover recipe will include the leftover recipe within the next 1-3 days or as indicated on the recipe.

To the extent that a user is entering a group and by way of example, the group may consist of a family with each individual sharing some similarities with others in the group but also some differences. For example, a family of four may consist of a mother and 6 year old daughter who want to lose weight, a father who wants to maintain weight, and a 13 year old boy who wants to gain muscle mass for sports activities. The system of the present invention allows the parent to select a family icon then walk through the bodyprint, taste test, lifestyle profile, and geneprint for each member. The mailing address, for example, on each family member profile stays the same and is automatically copied into each new family member profile as each new member is added. Once all data for each family member is entered, the parent initiates the meal plan function and a menu plan for the entire family is generated. All the meals/food are the same so the mother only cooks one thing for all family members, but the portion sizes will be different for each individual such as the boy having larger portions towards his goal of increasing his muscle mass. Alternatively or in addition, some family members may have different foods on their meal plan, such as the boy who may get additional protein.

This same process may be used in a school lunch program where the parents provide the data to the system for their children when they sign up each child for a new school year. Then, each child would receive a lunch specific to their needs.

Updating User Profile Information

Another feature of the system and methodology of the present invention is the ability to modify user profiles to generate a new diet plan based upon nutritional requirements when user data has changed. For example, if a user has lost weight, changed activity level or desires to try a new diet type, the meal plan may be updated based upon these changes which are entered by the user.

According to this process, the user logs into web site or software program and enters his/her user name and password. The user may be presented with various icons from which to click to update or change data but in this case the user clicks a “diet design” or similar icon because he/she needs a new diet based on new data. The user may next click on a “bodyprint” or similar icon so that the user can change, for example, body measurements, metabolic heart rate, and/or weight. This updates the user database 190 and may display for the user a weight tracking report, measurement tracking report, and/or metabolic heart rate tracking report that can be displayed in graphic or report format with adjusting time intervals.

This action may also update the BMI and daily caloric intake requirements for the user as applicable. If AMPS 100 notes the user has reached his/her weight goal, AMPS 100 may generate a popup window to congratulate the user and to suggest the user continue to follow the diet plan in a maintenance mode. The user can then be prompted to view the new personal BMI and daily caloric recommendations data.

Once the user is finished updating the bodyprint, the user clicks finish. Then the user is presented with a screen that displays the information entered and permits the user to edit any data, and/or select a start date for the new diet. The user is prompted with a window that says the menu plans have changed as a result of the bodyprint changes and queries whether the user want to view it now or later. The user then clicks on the diet design profile icon and changes, for example, the PCF ratio and changes the total daily folate requirement if applicable.

Once the user is finished updating the diet profile, the user clicks finish/update menu plan. Then user is presented with a screen that displays the information entered and allows the user to edit any data, and/or select a start date for the new diet. This action results in a newly generated menu plan. The user is prompted with a window that says the menu plan has changed as a result of the new diet profile changes and queries whether the user wants to view it now or later.

The user may then click on the medical log icon and, for example, change the health condition to indicate user has a cold, input a new lower blood pressure number, and/or changes the cholesterol LDL and HDL data to a lower number. Once the user is finished updating the medical log, the user clicks finish. Then user is presented with a screen that displays the information entered and allows the user to edit any data and/or select a start date for the new diet. This action results in a newly generated menu plan. The user is prompted with a window that says the menu plan has changed as a result of the new diet profile changes and queries whether the user wants to view it now or later. Based upon these updates, meal planning engine 140 generates a new meal plan according to the process described above.

Genomic Based Meal Planning

The system of the present invention may also use genomic information provided by the user in connection with preparing meal plans. As discussed above, it is now understood that certain genetic characteristics favor specific foods, specific ingredients, specific levels of nutrients and specific caloric intake levels for maximum health. According to the teachings of the present invention, this information which is provided by a user or on behalf of a user may be considered in developing specific meal plans for users. The process for registering a new user and incorporating genomic information into the meal planning for that user may occur as follows.

First, the user logs into web site or the software program. Next, the user clicks on the create new user icon. Next, the user enters personal information such as name, address, telephone, and email address. Then the user is told there are four functional steps to develop the meal plan using genomic data—the BodyPrint, Taste Test, Lifestyle Profile, and the GenePrint. In a preferred embodiment the user is prompted first to the BodyPrint screen. The screens for entering information as described below may, in a preferred embodiment, resemble the screen shown in FIG. 3 for entering user data in a non-genomic embodiment.

The Bodyprint screen preferably includes boxes to check or enter information concerning the following:

gender

birth date

height weight

desired weight

if pregnant or nursing

body frame

size measurements for biceps, triceps, forearms, neck, chest, waist, hips, upper thigh, mid thigh, knee, calves, ankle, dress size, shirt size, pant size

metabolic heart rate

current body fat percentage

desired body fat percentage

fat calculation method

The Activity and Medical Information screens accessed by clicking on the applicable tab may, in a preferred embodiment, be similar to that described above for the non-genomic embodiment. Further the process proceeds in a similar fashion to that described above for the non-genomic environment including querying for diet goals and determining a before and after state as described above. Similarly, the taste test screen and the lifestyle screen and the related process may also be the same or close to that of the non-genomic embodiment of the present invention.

Next, the user is presented a GenePrint screen. Gene data can be entered manually, or through an external data feed from an external source into AMPS 100 by, for example, a Doctor, a Nutritionist, or a DNA testing facility. Alternatively, the data feed can be emailed to the user from a service company providing such data and/or a doctor, a nutritionist, or a DNA testing facility. Preferably, if the GenePrint data is emailed to the user, the data will come in a form compatible with the software or web application. In the case where the user has software installed on their hard drive, the user will open the attachment in the email and press upload GenePrint. The GenePrint data (DNA codes) will be automatically uploaded into the user's personal profile. If there are multiple user profiles, the user is prompted to indicate which profile the GenePrint matches.

In the event the user is accessing the application via the web, the data feed can be uploaded into the GenePrint section of the BodyPrint area by the user, the doctor, the nutritionist, or another service designed for this purpose. In this scenario it is assumed the upload is done from a data file that has been emailed from the DNA testing facility.

The DNA testing facility also could have a customer number which would be stored on the user's computer. In this case, when the GenePrint is generated, the DNA testing facility automatically updates the user's software. Or, the DNA testing facility could provide the data to a service company which does this.

In the event DNA codes are not able to be uploaded automatically, anyone with access to the user's computer or web site profile can enter the DNA codes manually. Once the GenePrint data is successfully entered or uploaded, a report is made available to the user describing the data, the resulting conditions on the body, and what nutrition the body needs to regain or maintain health. This data also triggers the system to customize the nutritional training components for the user based on the specific nutritional needs of that dieter.

Also, each gene code has corresponding nutrient requirements for each user, so in the event that person's nutritional requirements are different than the RDA/I requirements, the nutritional profile in the diet design is updated so menu plans specific to those needs are generated. The user may then be presented with a screen that displays the information entered and allows the user to edit any data, and select a start date for the diet.

The system then uses the data discussed above to generate a diet specific to that person's unique bodyprint, taste test and lifestyle. The user is directed into the food log and is shown the first day's meal plan.

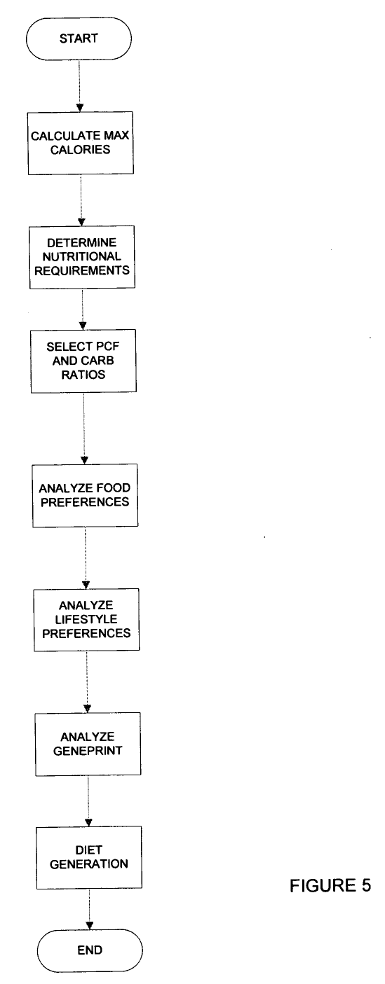

The process for determining a food plan customized for a user based upon genomic data may proceed as follows according to a preferred embodiment of the present invention and as illustrated in FIG. 5. First, data for the person's bodyprint is established (age, gender, height, weight, planned activity level). This data is used to calculate the user's preferred daily allowable caloric intake as follows. The user's BMR (formula based) is added to the planned energy expenditure (kj) (formula based) number to determine the number of daily calories that the user's body will burn each day. Then the number of pounds the person needs to lose per week is converted into calories and that sum is deducted from the planned energy expenditure number to arrive at the person's daily allowable caloric intake.

Next, the user's nutritional goals are determined. Based on the age and gender of the user, AMPS 100 uses the American Dietary Association's Recommended Daily Allowances (other sources could also or alternatively be used) of nutrients to determine the daily intake nutrient requirements for the user. There are minimums and maximums for each nutrient, and the allowable range is provided by person for each nutrient.

Next, a PCF ratio and a Carb ratio are selected for the user. The daily carbohydrate ratio is the percentage of high complex carbohydrates versus low complex carbohydrates allowed on the diet. Then medical conditions (illnesses, diseases, history of disease of user and user's family) for the user are retrieved from user database 190.

Next, the user preferences for foods and lifestyle are analyzed as discussed above. Once this has been completed, data from the geneprint is accessed for the user and a gene report is created based upon the DNA codes supplied by the user or on behalf of the user as discussed above. Once the DNA codes are received they are matched against nutrient needs. In a preferred embodiment, a specific number of grams for each nutrient is matched to each DNA code. This number may be a maximum or minimum number for the nutrient as determined for each DNA code through research. These research values for identified DNA codes may be either stored within AMPS 100 or updated from external sources periodically or they may be accessed from an external source in real time during the generation of each diet plan.

Once the nutrient grams are provided, the nutrient RDA/I profile for the dieter is updated to reflect the new nutrient quantities. Also, a report may be generated for the user by displaying information associated with each gene code that may include, for example, the name, the medical condition caused by the gene, medical treatments recommended, nutritional treatments recommended, and education on each nutrient.

In a preferred embodiment, food database 150 houses all available recipes and food items. This database 150 provides all calories, pcf ratios, and nutritional information for all food and recipe items. Initially, meal planning engine 140 combines recipes that create whole snacks and meals for breakfasts, lunches, and dinners. If one specific diet were being designed for one specific user, the number of calories per meal and snack for that user would be determined. For example, if the user should eat 1200 calories/day each meal should have 300 (+50 or −50) calories and each snack should have 100 calories (+30 or −30) so the combined meals and snacks should sum 1200 calories.

Meal planning engine 140 then sorts through a list of meals, snacks, recipes, food items, and beverages (which all have calories and nutrient amounts defined per meal, snack or recipe or food item) and selects/combines various items whereby the end result is a day's list of food for breakfast, morning snack, lunch, afternoon snack, dinner, and an evening snack that meet the daily caloric, preferred PCF ratio, preferred carb ratio, and daily nutritional requirements.

After each item or items are selected, the total daily calories, PCF ratio, and nutritional % met of RDA are calculated. These results are then compared as against a database with the RDA minimums and maximums of each nutritional value, and meal planning engine 140 determines if the nutrient falls within the daily allowable nutritional range. If not, the nutrients falling outside the range are noted, and adjustments are made to the daily food items and this process is repeated until a full day's of meals are recorded that meet the calorie, nutritional and pcf ratios.

Also, when selecting food, snack, meal items, meal planning engine 140 must access, for each individual user, the list of foods allowed and disallowed to confirm eligibility of each recipe based on the user's preferred food tastes and lifestyle. This process is repeated for the number of days the user needs to be on the diet to achieve the desired weight. In a preferred embodiment, there is a requirement to not repeat recipes within the first 21 day cycle then recipes can be repeated only within 6 day cycles thereafter. Further, in a preferred embodiment, each day limits to only one serving of beef, poultry, fish, a vegetarian dish, or pasta each. Recipes that indicate a leftover recipe will include the leftover recipe within the next 1-3 days or as indicated on the recipe.

Meal plans which are based upon genomic information can be updated based upon changes to the user profile in much the same way as discussed above with respect to meal plans based solely on non-genomic information. For example, if two new genes have been mutated and the result is that research calls for an increase in the nutrient values for biotin and niacin for those with these genes, AMPS 100 can process this information and re-generate a meal plan for the affected user(s).

One way that this can be accomplished is when new data about genes becomes available, AMPS 100 can scan the user database 190 for users with the affected genetic makeup and notify those users about the new information and possible changes in recommended diet planning. Those users could then log on and review the new data and then choose to accept the data and cause AMPS 100 to generate a new meal plan based upon the newly available data. Alternatively, users could configure their use of the system so that the meal plan is automatically updated as new, external nutrigenomic data becomes available possibly without the user even knowing about the change to the diet plan.

Separately, changes specific to each user such as weight gain or loss, a revised genomic test resulting in new genomic data for that user, lower blood pressure, etc, can be entered into the system by the user and caused to generate a new genomic based meal plan for that user based upon the new information.

Various other features of the present invention are also available in a preferred embodiment. For example, meal plans which are generated from the available foods in food database 150 may be associated with a shopping list which may be generated for a user. For example, each of the food and ingredient entries in food database 150 may be tagged with an availability field which specifies where each food or ingredient may be obtained. Thus, a shopping list for one or more stores may be made available to the user to take to each of the stores (e.g. a general grocery store and a specialty food shop) to obtain the necessary foods for the customized meal plan.

In yet another embodiment, AMPS 100 may communicate electronically via email or via some other agreed to protocol with one or more servers or email addresses, as applicable in order to automatically generate orders for food and/or ingredients, supplements, or drugs on behalf of the user. These ingredients, foods, supplements, or drugs preferably make up all of the necessary items to implement the customized meal plan for the user. The foods, ingredients, supplements, or drugs may be sourced from one or more suppliers and the user may pick up the items at the stores or caterer or it may be delivered to the user periodically as meal plans are generated over time.

Based upon a user preferences, such as the user's preferred grocer, AMPS 100 may select food purchases from preferred grocers and more than one grocer could supply food based upon inventory availability at particular grocers with preferred grocers having the first chance to supply the desired foods. In this embodiment, AMPS 100 preferably may receive inventory and other data from various suppliers such as grocers on a periodic basis so that AMPS 100 can determine shopping lists and fulfillment obligations for each supplier. Alternatively, AMPS 100 could send the summary of all foods or other items needed to a central clearinghouse which could process priorities and inventories in order to determine which supplier fulfills the order and to what extent.

AMPS 100 could also act as a stand alone application offered by a grocer on a grocer's website or AMPS 100 could be embodied as an Application Service Provider (ASP) application for a bricks-and-mortar grocer or online grocer who fulfills only from their inventory.

Still another feature of AMPS 100 in one preferred embodiment is one or more supplemental applications 180 available to users. Such applications may include chat rooms and message boards where users may communicate with one another and with staff for support and information regarding the meal plans, dieting and health issues in general. Other applications available via supplemental applications functionality 180 may include a food search tool that allows a user to search for particular foods, menus, meals and diets and obtain information about each of these or manually build their own meal plan. Comparison tool 170 may be included in AMPS 100 and may permit users to search for and compare various foods, meals, diets, etc in terms of costs, calories, nutritional content, time to prepare and other factors.

Another possible feature of the system of the present invention is the ability for the individual or group of individuals to interact with professionals such as doctors, nutritionists, personal trainers, psychologists, etc. who will have access to a patient's account. The professional may make changes or recommended changes to any part of the system or any grouping of data. Various password restrictions may be applied restricting access to none, some or all parts of the user profile and user data stored in user database 190 and elsewhere in AMPS 100. The system may also include a dialog feature to record dialog between the user and a professional and a feature for the professional to post recommended treatments and definitions for the user. The professional may also input drug prescriptions which the user can print or which are automatically tied to a drug provider's system for purchase and delivery to the user.

The professional—user interaction feature may also includes a function to set up/design and provide on-going care/treatment therapies for the user or group of users which is posted and defined for the user in the user profile medical section. Tracking and reporting in this regard for on-going results for both the patient(s) and professional(s) may also be provided. Any new treatment recommended or changes made to a user's profile can be automatically emailed to the user notifying him/her of such changes or new therapies.

The system of the present invention may also include a function which may be embodied as an applet or other software program which is installed on the terminal 110 used by the professional. This application may provide for creation, storage and access to private notes and information about each patient that is not accessible by the patient and which can be shared with other professionals.

Another feature of the system which may be included is educational components delivered through games, DVD's, movies, newsletters, or text. These are customized to each user's needs.

Another unique feature which may be included with the system of the present invention is the Catering Applet. Users will have the ability to select caterers for home delivery of meals. Once a caterer is selected, and orders are placed, caterers will have an applet that notifies them of an order, a new customer profile (that will be a sub-set of customer data profile information) will be generated for them, and an inventory management and food preparation management system will allow caterers to plan the shopping, preparation, and delivery schedules to deliver to a small or large audience. Their terminals 110 may be electronically connected with food grocers or wholesalers. The system preferably limits the universe of foods so as to provide optimal profitability through scale.

As alluded to above, the system of the present invention may provide a caterer with an automated application and database for dieter ordering, shopping, preparation and packaging planning, and delivery management for a catering business. According to this embodiment, the system of the present invention may provide a list of all dieters, delivery addresses, and meal plans specific to each dieter but optimized across like dieters for purposes of scale. The system may then transmit data to the caterer such as a summary food shopping list, preparation and packaging planning, and delivery management of daily meal deliveries for specific timeframes.

Throughout the disclosure, individuals or groups of individuals are referenced. The system allows for custom menu plans and treatments to be generated for more than one person where as one meal plan and therapy suit the needs of all individuals (in a family for example). In this case each person may have unique requirements, i.e. one person may aim to lose weight, one may aim to gain muscle mass, and one may be a diabetic, and one may just want a nutritional plan that allows weight and body maintainance.

Contests and celebrity status of professionals or dieters may be automatically recognized and displayed on the community site through an application that calculates such status. The ability for individuals or the AMPS 100 to import/export user files, food, recipes, etc. to one another or into AMPS 100 is also possible.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims, and by their equivalents.

What is claimed is:

1. A meal planning system comprising:
(a) at least one terminal for providing a plurality of individual characteristics representative of a user's physical condition;
(b) a database storing recommended nutritional intake levels;
(c) a meal planning engine, said meal planning engine generating at least one meal plan for said user based upon said plurality of individual characteristics and said recommended nutritional intake levels;
(d) wherein said recommended nutritional intake levels comprise at least recommended maximum or minimum levels for micronutrients.

2. The meal planning system of claim 1 wherein said database further stores recommended caloric intake levels and said meal planning engine generates said at least one meal plan based thereon.

3. The meal planning system of claim 1 further comprising at least one food database wherein said meal plan is based upon the universe of available foods contained in said at least one food database.

4. The meal planning system of claim 1 further comprising a genomic database, said genomic database containing information concerning recommended dietary guidelines based upon the presence of specific genetic characteristics and wherein said meal planning engine generates said at least one meal plan based thereon.

5. The meal planning system of claim 1 wherein said meal planning engine is located on server accessible through the Internet by said at least one terminal.

6. The meal planning system of claim 1 wherein said meal planning engine comprises a stand alone application located on a personal computer.

7. The meal planning system of claim 1 wherein said generated meal plan may be routed to an external computing device for automatic ordering of ingredients or foods contained in said meal plan.

8. The meal planning system of claim 1 further comprising a medical therapy engine, said medical therapy engine operating to generate and track medical therapy regimens based upon said plurality of individual characteristics.

9. The meal planning system of claim 1 wherein meal plans are generated for groups of users sharing at least one of said plurality of individual characteristics.

10. A method for generating a meal plan comprising the steps of:
(a) receiving a plurality of individual characteristics representative of a user's physical condition;
(b) obtaining recommended nutritional intake levels;
(c) generating said meal plan for said user based upon said plurality of individual characteristics and said recommended nutritional intake levels;
(d) wherein said recommended nutritional intake levels comprise at least recommended maximum or minimum levels for micronutrients.

11. The method of claim 10 further comprising the step of obtaining and storing recommended caloric intake levels and generating said at least one meal plan based thereon.

12. The method of claim 10 further comprising the step of obtaining and storing food information wherein said meal plan is based upon the universe of available foods contained within said food information.

13. The method of claim 10 further comprising the step of obtaining genomic data, said genomic data containing information concerning recommended dietary guidelines based upon the presence of specific genetic characteristics and wherein said meal plan is generated based thereon.

14. The method of claim 10 further comprising the step of routing said generated meal plan to an external computing device for automatic ordering of ingredients, supplements, drugs or foods contained in said meal plan.

15. The method of claim 10 further comprising the step of generating and tracking medical therapy regimens based upon said plurality of individual characteristics.

16. The method of claim 10 wherein meal plan is generated for groups of users sharing at least one of said plurality of individual characteristics.
